(19) United States
(12) Patent Application Publication
(10) Pub. No.: US 2025/0348106 A1
(43) Pub. Date: Nov. 13, 2025

(54) SYSTEM AND METHOD FOR SOURCE SYNCHRONOUS IMPLEMENTATION

(71) Applicant: Microsoft Technology Licensing, LLC, Redmond, WA (US)

(72) Inventors: Matthew Donald Youngblood, Raleigh, NC (US); Richard Duane Tax, Cary, NC (US); David Weitzel, Cary, NC (US); Naga Sai Gowtham Kumar Hari, Holly Springs, NC (US); Frederick John Pentek, Cary, NC (US); Charles Kenneth Robinson, Cary, NC (US); Charles John Stratakos, Saratoga, CA (US); Yan Zhang, Cary, NC (US); Sherwin Craig Murphy, Jr., Cary, NC (US)

(21) Appl. No.: 18/661,342

(22) Filed: May 10, 2024

(51) Int. Cl. G06F 1/10; H04L 1/00

(52) U.S. Cl. CPC G06F 1/10; H04L 1/0071

(57) ABSTRACT

A method, computer program product, and computing system for identifying a plurality of signal propagation tracks within an integrated circuit, where the plurality of signal propagation tracks include metal layers in a metal stack within the integrated circuit. A plurality of candidate signal propagation paths are generated by determining a ratio of metal layer portions from a combination of discrete metal layer portions. The candidate signal propagation paths are divided into a plurality of candidate signal propagation path groups. A first set and a second set of propagation paths are generated from the plurality of candidate signal propagation paths, where the second set of signal propagation paths are variably offset from the first set of signal propagation paths.

### BACKGROUND

A typical chip network handles the routing of tens of thousands of independent signals to travel from various sources to specific destinations. These signals travel through “pipes” which are blocks that have minimal combinational logic and feed signals in a generally straight line from source to destination. Due to the number of signals, these pipes can reach critical dimensions requiring significant chip area, reducing the computational capacity of the system on a chip (SOC). As such, many approaches have been introduced to minimize pipe dimensions. For example, one of the primary methods to reduce the pipe dimensions is to increase signal density traveling through a pipe. However, when the signal route density is increased, the signals begin to couple with each other—a condition known as crosstalk. If crosstalk is not mitigated, the signals will reach their destination circuitry after the captured clock signals has fired or too early, either way corrupting the captured data.

### BRIEF DESCRIPTION OF THE DRAWINGS

FIG. 1 is a flow chart of one implementation of a source synchronous implementation process;

FIG. 2 is a diagrammatic view of a pipe within an integrated circuit in terms of processing logic for propagating data signals and clock signals within the integrated circuit according to one implementation of the source synchronous timing process of FIG. 1;

FIG. 3 is a diagrammatic view of a pipe within an integrated circuit in terms of a metal stack including multiple metal layers according to one implementation of the source synchronous implementation process of FIG. 1;

FIGS. 4-6 are diagrammatic views of signal propagation tracks within an integrated circuit according to one implementation of the source synchronous timing process of FIG. 1;

FIG. 7 is a diagrammatic view of the bundling of signal propagation tracks within an integrated circuit according to one implementation of the source synchronous implementation process of FIG. 1;

FIGS. 8-14 are diagrammatic views of candidate signal propagation paths generated within an integrated circuit according to various implementations of the source synchronous implementation process of FIG. 1;

FIG. 15 is a diagrammatic view of the saturation of multiple signal propagation paths of a particular metal layer type according to one implementation of the source synchronous implementation process of FIG. 1;

FIG. 16 is a diagrammatic view of the saturation of multiple signal propagation paths of another metal layer type according to one implementation of the source synchronous implementation process of FIG. 1;

FIGS. 17-21 are diagrammatic views of the generation of two candidate signal propagation paths, the dividing of the candidate signal propagation paths into candidate signal propagation groups, and the generating of signal propagation paths for each candidate signal propagation group according to various implementations of the source synchronous timing process of FIG. 1;

FIG. 22 is a three-dimensional diagrammatic view of the bundling of signal propagation tracks within an integrated circuit according to one implementation of the source synchronous implementation process of FIG. 1;

FIG. 23 is a three-dimensional diagrammatic view of signal propagation paths with offsets for a first candidate signal propagation group according to various implementations of the source synchronous timing process of FIG. 1; and

FIG. 24 is a diagrammatic view of computer system and source synchronous implementation process coupled to a distributed computing network.

Like reference symbols in the various drawings indicate like elements.

### DETAILED DESCRIPTION OF THE PREFERRED EMBODIMENTS

Implementations of the present disclosure enable source synchronous implementation by saturating the maximum available resource while ensuring that signals reach their destinations at the correct time (dictated by the capture clock arrival). For example, on a chip, there are a number of layers of different metal types, some in horizontal directions, others in vertical directions. For a pipe that is propagating signals horizontally from left to right, the signals will populate all of the horizontal resource available. Similarly for a vertically oriented pipe, the vertical layers will be populated by the signals. Each layer on a chip has different resistance and capacitance (RC) characteristics. The differences between the layers means that if each layer was saturated with some number of signals exclusively routed on a single layer,, at least some signals (on favorable RC layers) would travel much faster than signals on less favorable RC layers. This would result in some signals reaching their destination flops after the captured clock has fired or too early, either way corrupting the captured data.

Implementations of the present disclosure provide functional source synchronous timing by accounting for the RC characteristics of each layer of the chip, and by proportionally allocating each pipe signal to an equal ratio of ideal and non-ideal RC layers. For example, by propagating each signal in signal paths with the same proportion of ideal and non-ideal RC layers, and by implementing the clock signals with the same mixture, the process guarantees that all of the signals will arrive within an acceptable window of time relative to the capture clock arrival. Accordingly, the process understands the ratio of different metal layer portions between each layer, dictated by its RC characteristics as well as how many signals it can support, and efficiently saturates all available resources on each layer while ensuring that an identical mix of ideal and non-ideal RC layers is used for each signal.

For example, the source synchronous implementation process identifies a plurality of signal propagation tracks within an integrated circuit, where the plurality of signal propagation tracks include a plurality of metal layers in a metal stack within the chip (also referred to as an integrated circuit). A plurality of candidate signal propagation paths (i.e., all of the potential channels through the integrated circuit that signals may propagate on) are generated by determining a ratio of metal layer portions from a combination of discrete metal layer portions from the plurality of metal layers. For example, as each metal layer has distinct impedance characteristics (i.e., resistance, capacitance, inductance, etc.), combining various metal layer portions allow saturation of the signal propagation paths while ensuring that signals propagate through the signal propagation paths within a threshold amount of time of one another. For example, when generating candidate signal propagation paths, the ratio between metal layer portions be non-ideal or impractical for implementation. In one example, suppose that an ideal ratio requires 38 metal layer portions of one metal layer and 21 of another metal layer. In this example, a ratio of 3-to-2 may be used which results in certain candidate signal propagation paths that are extraneous.

The plurality of candidate signal propagation paths are divided into a plurality of candidate signal propagation path groups with a first set of signal propagation paths and a second set of signal propagation paths, where the second set of signal propagation paths are offset from the first set of signal propagation paths. In some implementations, the first and second set of signal propagation paths are variably offset from one another and/or interleaved to prevent crosstalk or other signal distortion between adjacent signal propagation paths and to provide synchronous data signals and clock signals (i.e., source synchronous signals). However, source synchronous signals are very noisy at almost every point along the signal propagation path because of crosstalk. Accordingly, by staggering the signal propagation paths, the amount of crosstalk among signals is reduced without delaying data signals relative to clock signals or vice versa.

The details of one or more implementations are set forth in the accompanying drawings and the description below. Other features and advantages will become apparent from the description, the drawings, and the claims.

### The Source Synchronous Timing Process

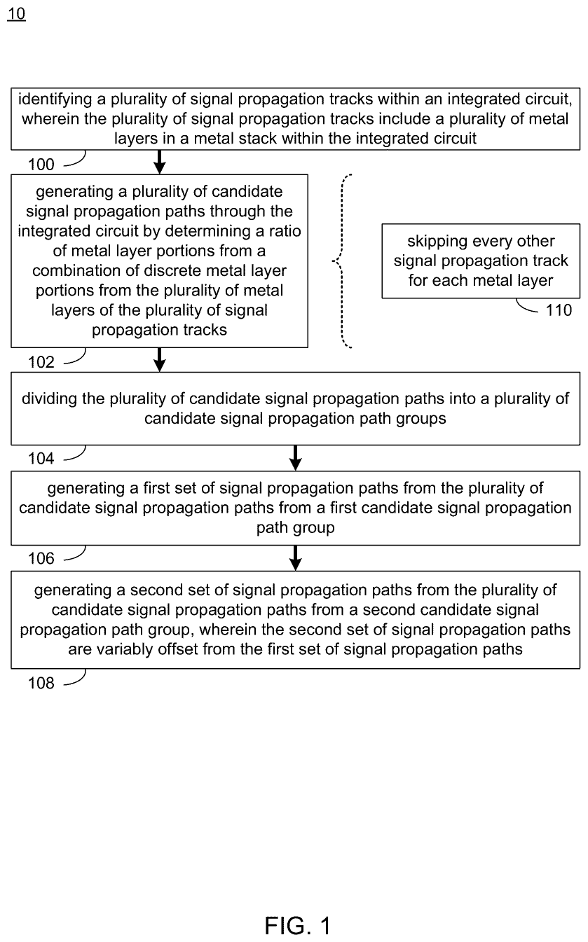

Referring to FIGS. 1-21, source synchronous process 10 identifies 100 a plurality of signal propagation tracks within an integrated circuit, where the plurality of signal propagation tracks include a plurality of metal layers in a metal stack within the integrated circuit. A plurality of candidate signal propagation paths through the integrated circuit are generated 102 by determining a ratio of metal layer portions from a combination of discrete metal layer portions from the plurality of metal layers. The plurality of candidate signal propagation paths are divided 104 into a plurality of candidate signal propagation path groups. A first set of signal propagation paths are generated 106 from the plurality of candidate signal propagation paths from a first candidate signal propagation path group. A second set of signal propagation paths are generated 108 from the plurality of candidate signal propagation paths from a second candidate signal propagation path group, wherein the second set of signal propagation paths are offset from the first set of signal propagation paths.

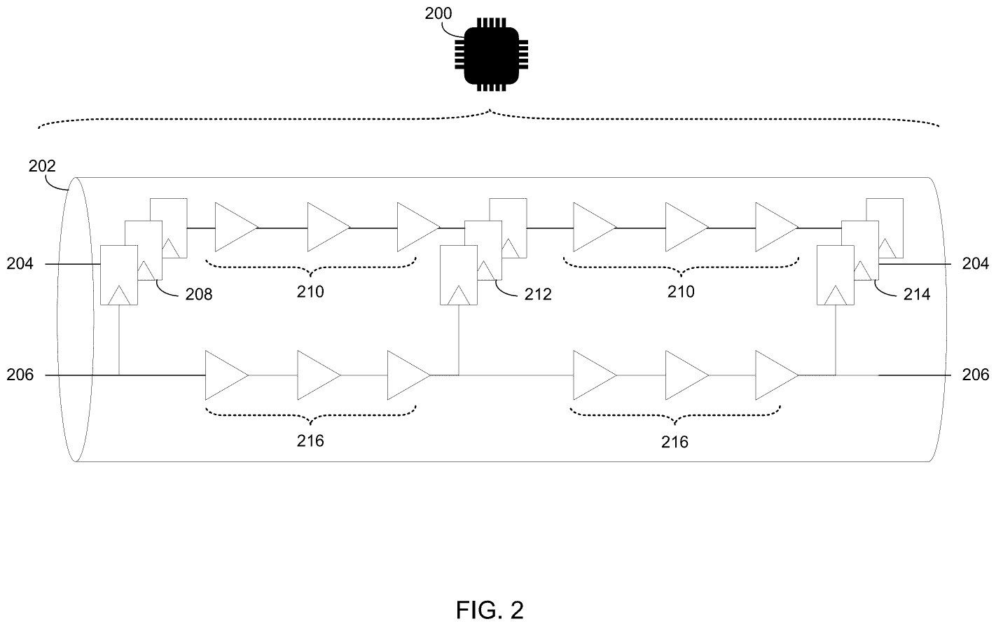

In some implementations, source synchronous process 10 identifies 100 a plurality of signal propagation tracks within an integrated circuit, where the plurality of signal propagation tracks include a plurality of metal layers in a metal stack within the integrated circuit. Referring also to FIG. 2 and as discussed above, an integrated circuit or chip includes various electronic components for propagating and processing signals. For example, an integrated circuit (e.g., integrated circuit 200) includes components including: semiconductor substrate, transistors, interconnects connecting components, dielectric layer, passive components (e.g., resistors, capacitors, inductors, etc.), and/or bonding pads for external power and/or signal connections. As will be discussed in greater detail below, various pipes (e.g., pipe 202) are logical representations of connections within integrated circuit 200 between components and channels for propagating signals throughout integrated circuit 200. As shown in FIG. 2, a pipe (e.g., pipe 202) includes, as input signals, a data signal (e.g., data signal 204) and a clock signal (e.g., clock signal 206). In one example, data signal 204 enters pipe 202 at a set of latches or flip flop circuits (e.g., input logic 208) that capture data signal 204 before propagating data signal 204 down the length of pipe 202. A plurality of data repeaters (e.g., data repeaters 210) are shown between the input set of latches (e.g., input logic 208), inner-pipe latches (e.g., inner-pipe logic 212), and an output set of latches (e.g., output logic 214). Additionally, clock signal 206 is similarly propagated using clock repeaters 216 and drives input logic 208, inner-pipe logic 212, and output logic 214. As data signal 204 and clock signal 206 propagate through pipe 202, each signal may be subject to unique impedance characteristics in the pipe that impact whether the signals are processed synchronously (i.e., received within a threshold period of time from one another).

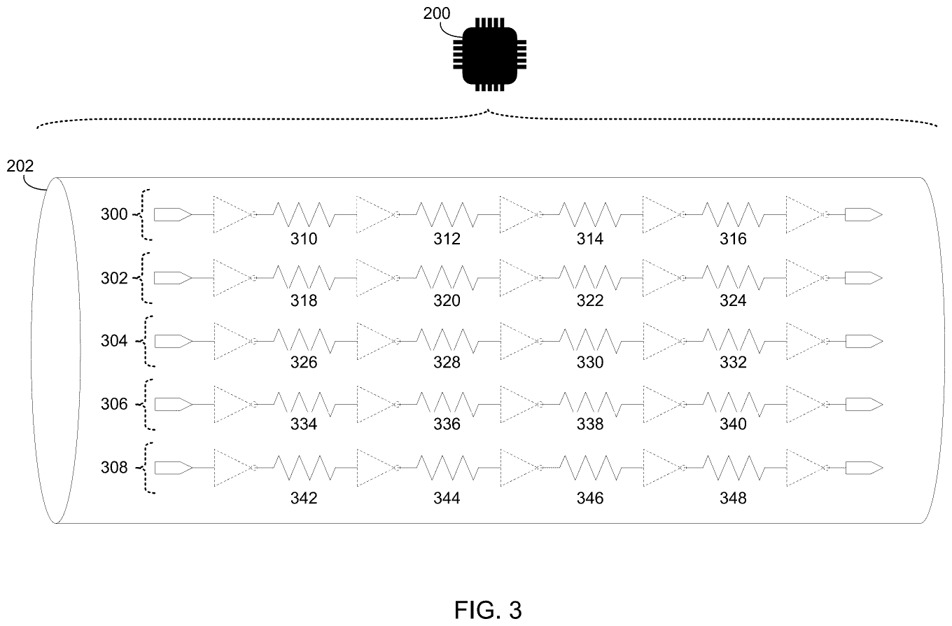

For example and in some implementations, pipe 202 includes various metal layers defining a metal stack. Referring also to FIG. 3, a plurality of metal layers (e.g., metal layers 300, 302, 304, 306, 308) are shown with multiple portions or segments (e.g., metal layer portions 310, 312, 314, 316 for metal layer 300; metal layer portions 318, 320, 322, 324 for metal layer 302; metal layer portions 326, 328, 330, 332 for metal layer 304; metal layer portions 334, 336, 338, 340 for metal layer 306; and metal layer portions 342, 344, 346, 348 for metal layer 308) defining predefined lengths or sections of each metal layer with particular impedance characteristics. For example, metal layers 300, 302, 304, 306, 308 include unique impedance characteristics (e.g., resistance, capacitance, and/or inductance) that impact how signals propagate through each respective metal layer (or metal layer portions thereof). As shown in FIG. 3, optional inverters are shown in broken lines between each set of metal layer portions. In some implementations, the plurality of metal layers include one or more of a plurality of horizontal metal layers and a plurality of vertical metal layers. For example, the metal stack (defined by metal layers 300, 302, 304, 306, 308) includes multiple metal layers with alternating horizontal and vertical directions. This allows signals to propagate horizontally and/or vertically within integrated circuit 200.

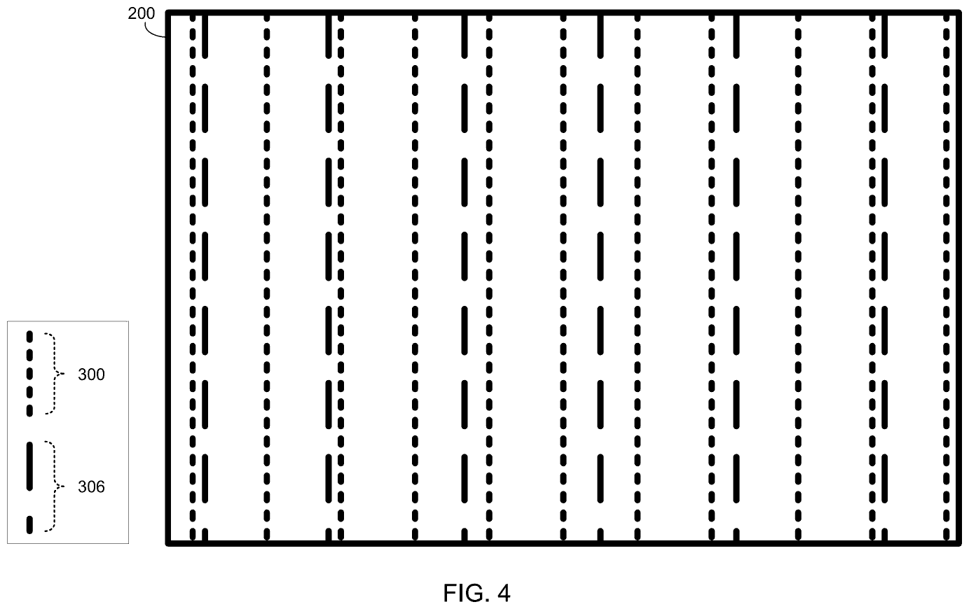

Referring also to FIG. 4, integrated circuit 200 is shown with a plurality of signal propagation tracks formed from two metal layer types (e.g., metal layer 300 and metal layer 306). A signal propagation track is a location within integrated circuit 200 for portions or segments of a metal layer. As shown in FIG. 4, signal propagation tracks formed from metal layer 300 are represented with a broken line while signal propagation tracks formed from metal layer 306 are represented with a dashed line. While several examples described herein reference two metal layers, it will be appreciated that this is for example purposes only and that the metal stack of integrated circuit 200 can include any number or sequence of metal layers. In some implementations, source synchronous process 10 identifies 100 a plurality of signal propagation tracks within integrated circuit 200 by identifying all usable signal propagation tracks in integrated circuit 200 and their impedance characteristics.

In some implementations, source synchronous process 10 generates 102 a plurality of candidate signal propagation paths through the integrated circuit by determining a ratio of metal layer portions from a combination of discrete metal layer portions from the plurality of metal layers. A candidate signal propagation path is a combination of metal layer portions or segments from the plurality of metal layers that a signal (either data or clock) can pass through without introducing delay or inconsistent arrival relative to other signals. For example and as shown in FIG. 3, metal layers 300, 302, 304, 306, 308 each have unique material properties that influence their impedance characteristics. In one example, metal layer 300 is a low resistivity metal layer that signals can propagate through more quickly than in a higher resistivity metal layer (e.g., metal layer 306). Accordingly, source synchronous process 10 generates 102 the plurality of candidate signal propagation paths through integrated circuit by combining metal layer portions from various metal layers to ensure that multiple signals propagate through the plurality of signal propagation paths synchronously (i.e., are received at the output of the signal propagation path within a predefined threshold of one another).

In some implementations, generating 102 the plurality of candidate signal propagation paths through the integrated circuit includes generating candidate signal propagation paths that include a plurality of discrete metal layer portions with the same impedance characteristics based upon, at least in part, a ratio of metal layer portions from a combination of discrete metal layer portions from the plurality of metal layers. For example, the time required to propagate a signal along a metal layer is dependent upon the impedance characteristics of the metal layer portions of the metal layer. In one example, the impedance of a metal layer is a function of the pitch of the metal layer. A pitch of a metal layer is a measurement of the metal layer portion width and space required for a given metal layer. In some implementations, lower metal layers of integrated circuit 200 have smaller pitches than upper layers which results in larger numbers of metal layer portions required for lower metal layers than upper metal layers. In some implementations, the number of metal layer portions may be dependent upon the directionality of the metal layers. For example, integrated circuit 200 includes certain metal layers that are vertical metal layers and other metal layers that are horizontal metal layers. Accordingly, source synchronous process 10 generates 102 the plurality of candidate signal propagation paths through the integrated circuit by accounting for the metal layers that are vertical and the metal layers that are horizontal. For instance, to maximize signal processing efficiency through integrated circuit 200, source synchronous process 10 generates candidate signal propagation paths that cover and include as many metal layers as possible to “saturate” the integrated circuit. In some implementations, source synchronous process 10 generates candidate signal propagation paths as mix of various metal layer portions to provide maximum saturation of the metal layers within integrated circuit 200.

In some implementations, source synchronous process 10 generates 102 candidate signal propagation paths with a number of metal layer portions based upon the number of signal propagation tracks. For example and as will be discussed in greater detail below, when source synchronous process 10 generates candidate signal propagation paths with “N” (i.e., an integer) signal propagation tracks, the number of metal layer portions within the candidate signal propagation path is an integer multiple of “N”. This ensure that every signal using the candidate signal propagation paths includes the amount of repeater stages (e.g., data repeaters 210 or clock repeaters 216) for propagating data signals and clock signals synchronously without degradation.

With these constraints, source synchronous process 10 determines a ratio of metal layer portions from multiple metal layers to define the plurality of candidate signal propagation paths. In one example, source synchronous process 10 determines the ratio by processing the minimum pitch for each metal layer. Returning to the example of FIG. 4, source synchronous process 10 determines that metal layer 300 has a pitch of 0.42 micrometers and metal layer 306 has a pitch of 0.76 micrometers. In some implementations, source synchronous process 10 determines the ratio for the metal layers by determining the least common multiple (LCM) for the pitch values. For example, using the pitch of 0.42 for metal layer 300 and the pitch of 0.76 micrometers for metal layer 306, source synchronous process 10 determines that the least common multiple is 15.96 which represents 38 portions of metal layer 300 and 21 portions of metal layer 306. Accordingly, signals can propagate equivalently through a layer with 38 portions of metal layer 300 or 21 portions of metal layer 306. In some implementations, with impedance of a candidate signal propagation path defined as the sum of the impedances of each metal layer portion and the application of the commutative property of addition, any combination or arrangement of metal layer portions in a candidate signal propagation path including 38 metal layer portions from metal layer 300 and 21 metal layer portions from metal layer 306 results in the similar impedance characteristics.

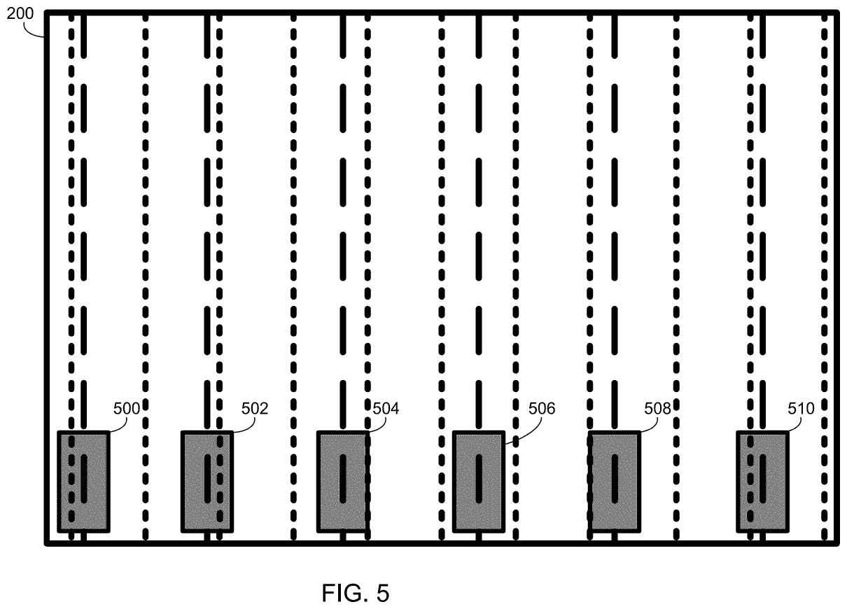

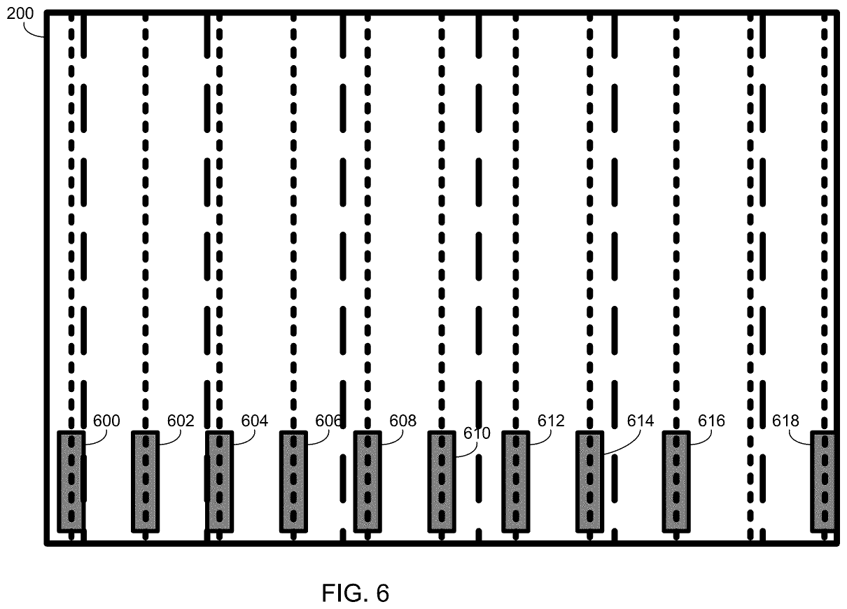

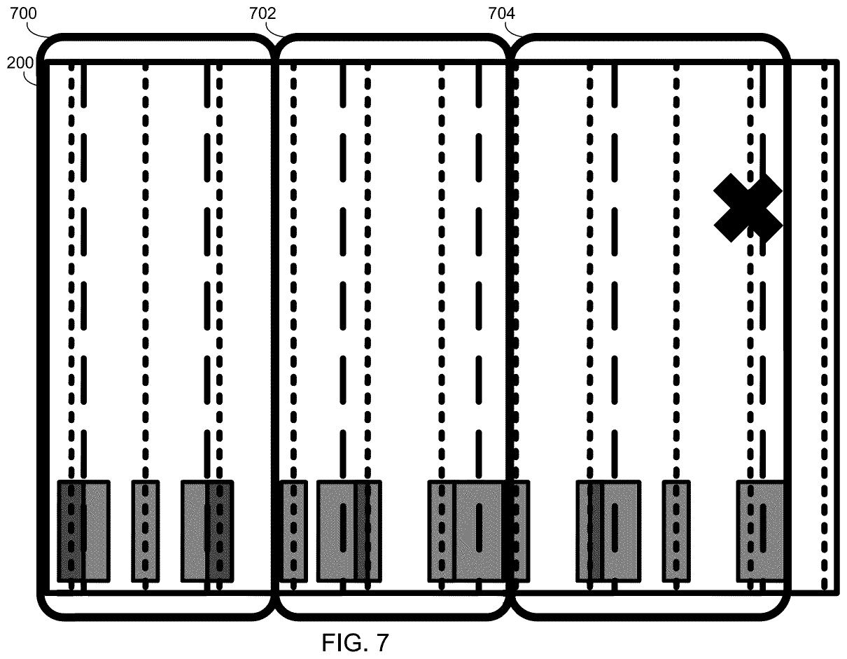

However, this ratio of 38 metal layer portions of metal layer 300 and 21 metal layer portions of metal layer 306 may be impractical. Accordingly, source synchronous process 10 determines a simplified ratio of e.g., three metal layer 300 tracks to two metal layer 306 tracks. Referring also to FIG. 5, metal layer portions 500, 502, 504, 506, 508, 510 are shown on signal propagation tracks of metal layer 306. Referring also to FIG. 6, metal layer portions 600, 602, 604, 606, 608, 610, 612, 614, 616, 618 are shown on signal propagation tracks of metal layer 300. Source synchronous process 10 generates 102 candidate signal propagation paths using combinations of these metal layer portions by defining bundles of metal layer portions per the ratio defined above (i.e., three metal layer 300 tracks to two metal layer 306 tracks). Referring also to FIG. 7, source synchronous process 10 generates bundles of signal propagation tracks by (in this example) counting signal propagation tracks from left to right until three metal layer tracks of metal layer 300 and two metal layer tracks of metal layer 306 are identified. In this example, source synchronous process 10 generates signal propagation tracks bundles 700, 702, 704. As shown in this example, there is a signal propagation track for metal layer 300 that is physically within signal propagation track bundle 704 but is skipped (denoted by the “X” over the signal propagation track in FIG. 7). As such, source synchronous process 10 skips over signal propagation tracks that overlap with an existing bundle of signal propagation tracks to ensure alignment of the signal propagation tracks with signal propagation track bundles.

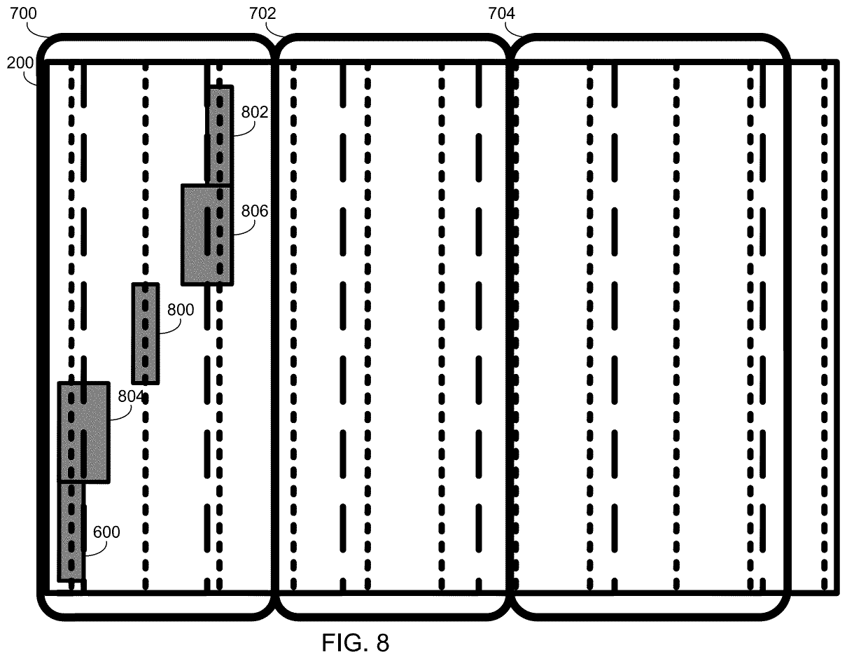

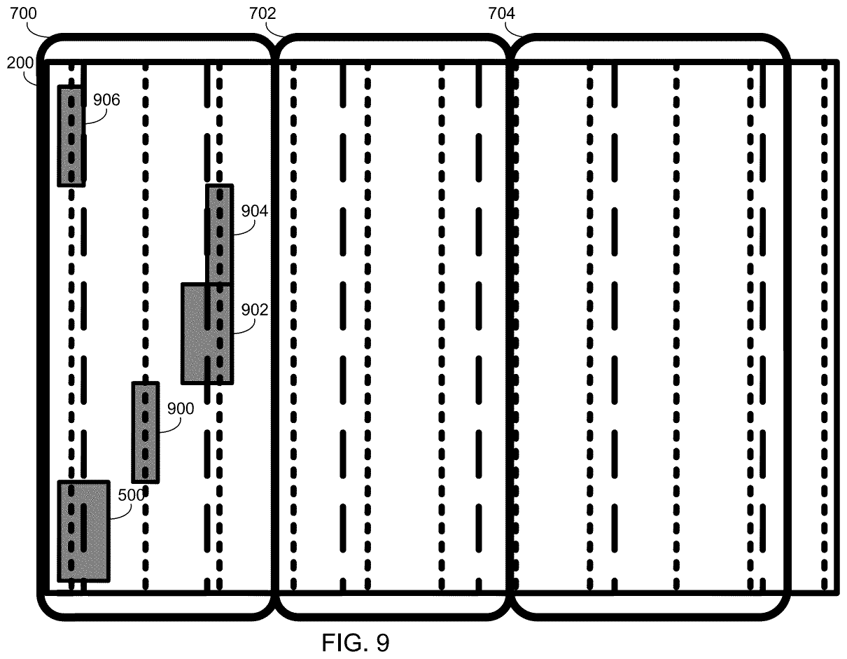

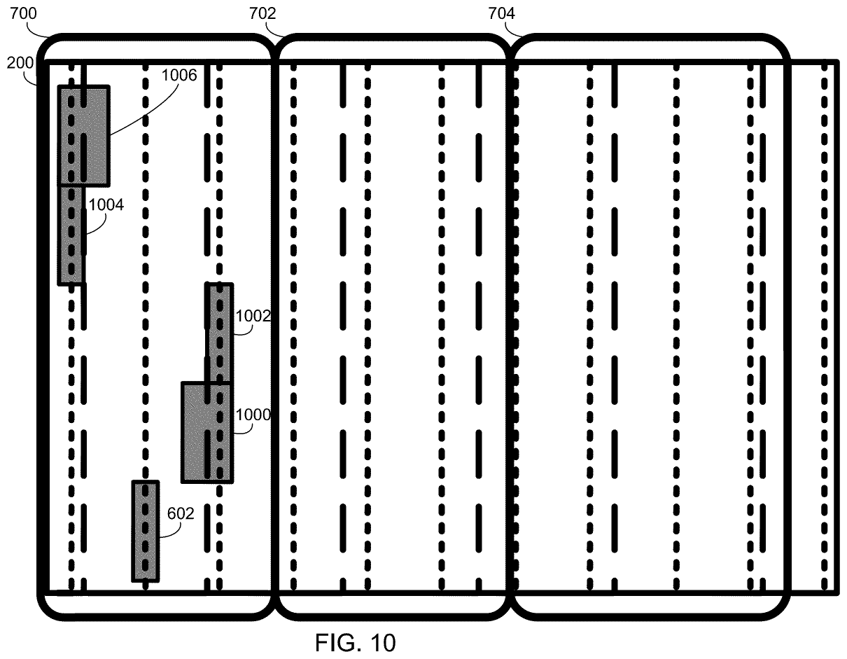

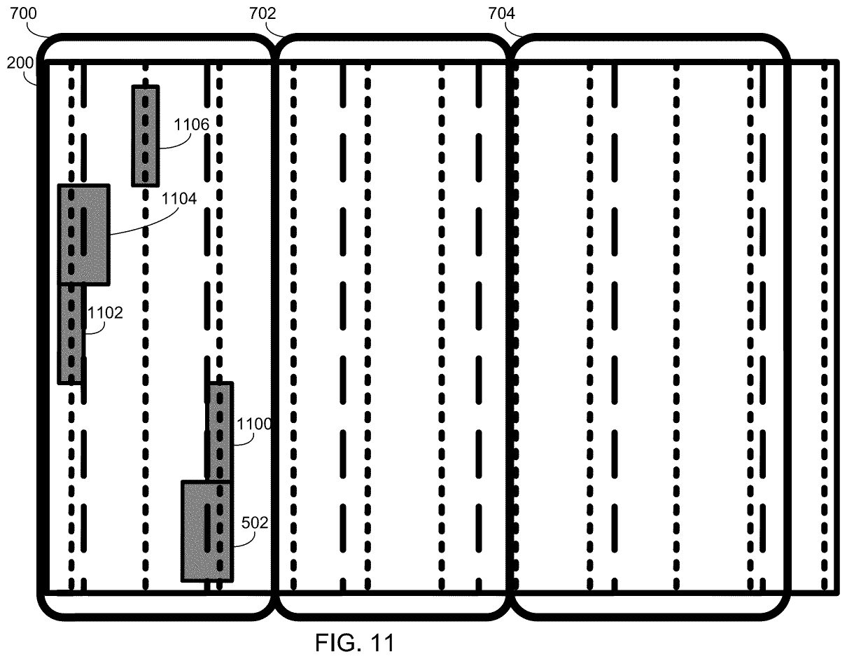

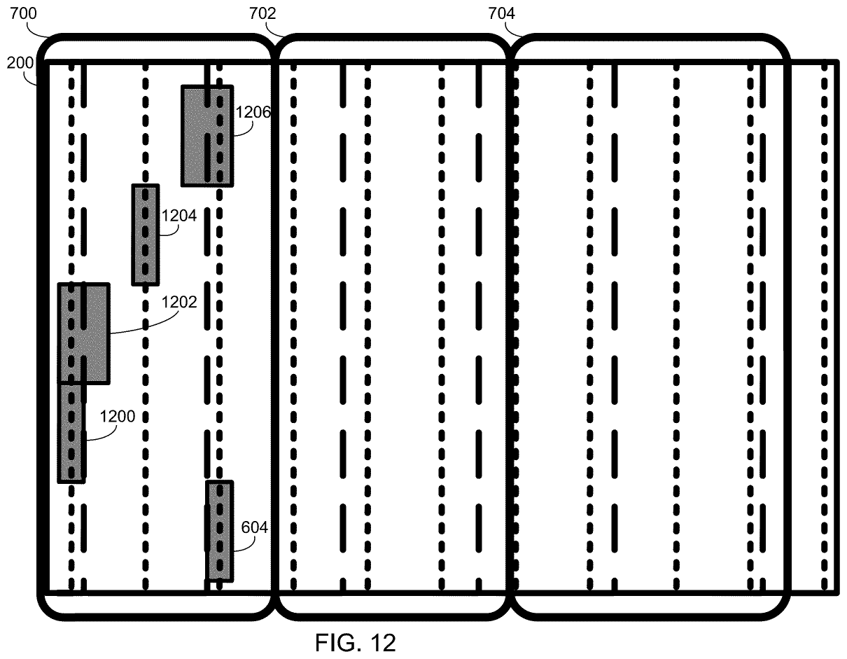

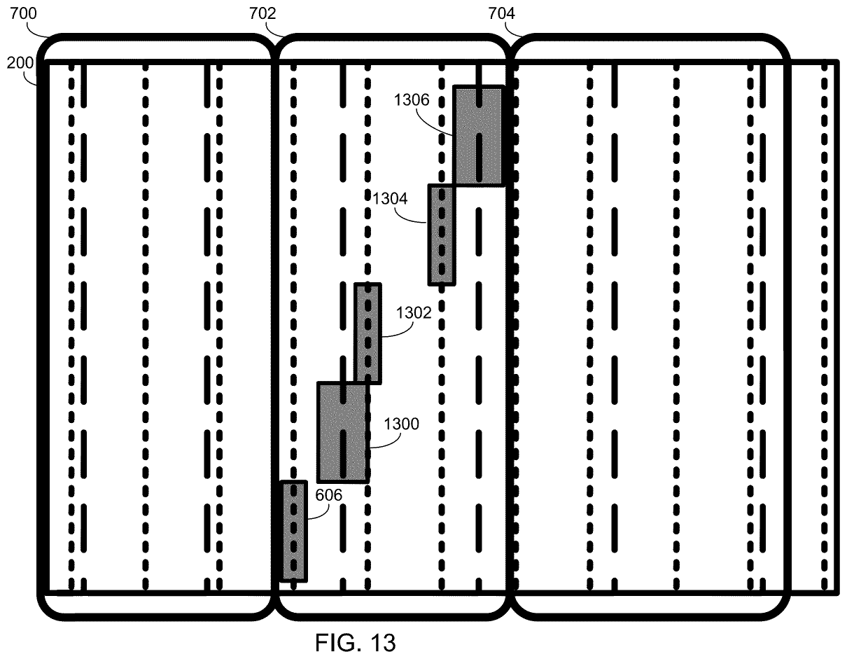

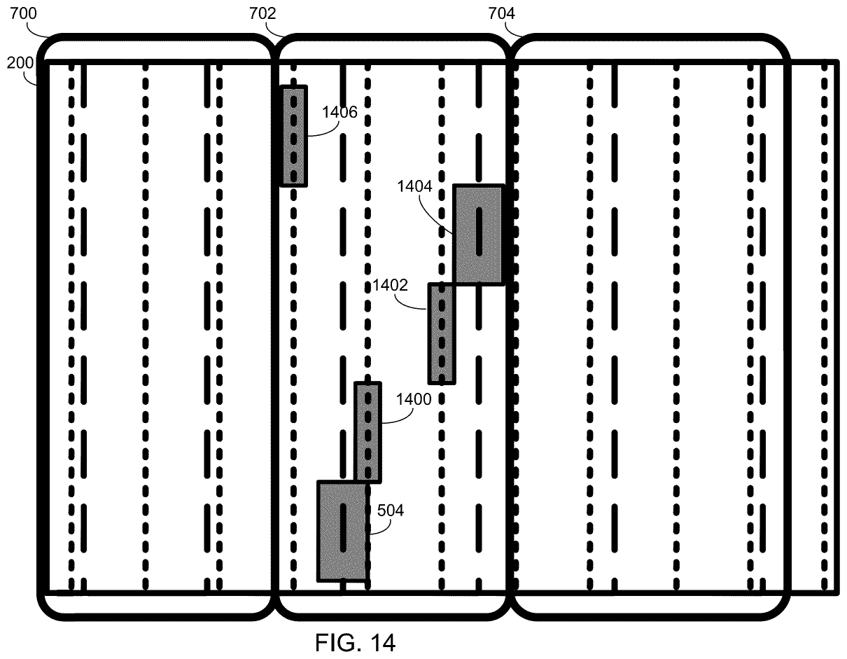

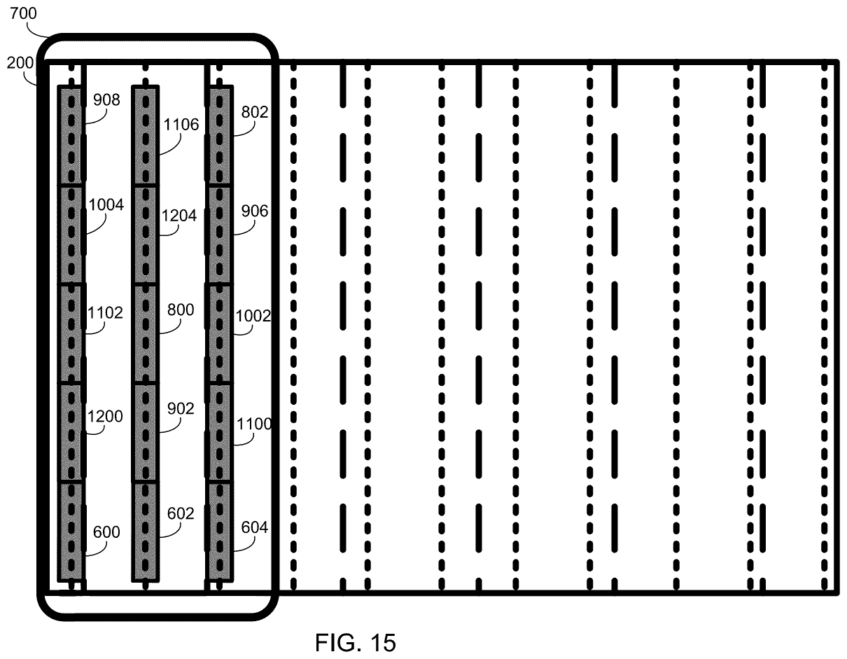

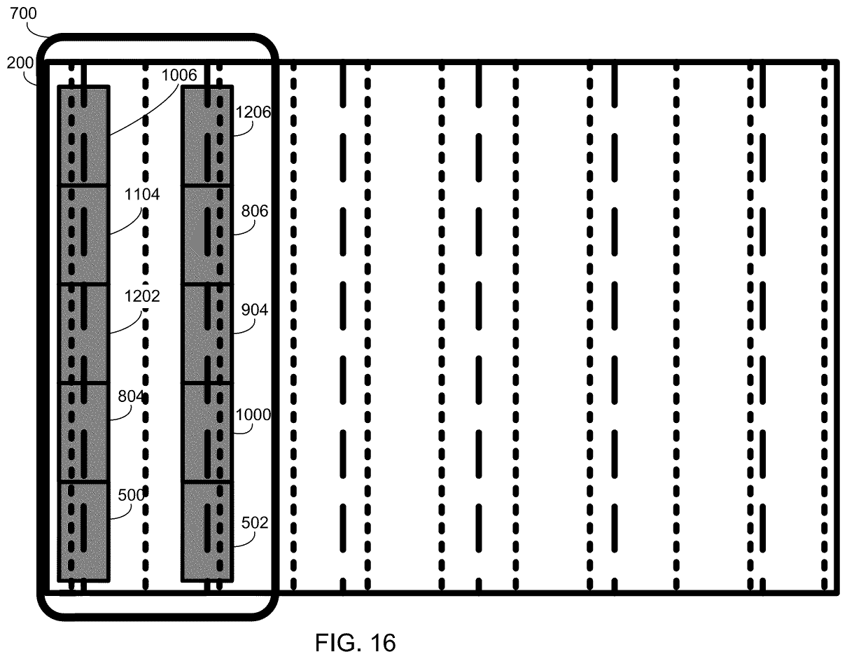

Referring also to FIG. 8 and in one example, source synchronous process 10 generates 102 a candidate signal propagation path for multiple signals from signal propagation tracks bundle 700 by selecting metal layer portions 600, 800, 802 from the three signal propagation tracks formed from metal layer 300 and metal layer portions 804, 806 from the two signal propagation tracks formed from metal layer 306. This is repeated in FIGS. 9-14 for different candidate signal propagation paths. Accordingly, source synchronous process 10 generates 102 a candidate signal propagation path with metal layer portions 900, 902, 904, 906, 908 as shown in FIG. 9; a candidate signal propagation path with metal layer portions 602, 1000, 1002, 1004, 1006 as shown in FIG. 10; a candidate signal propagation path with metal layer portions 502, 1100, 1102, 1104, 1106 as shown in FIG. 11; and a candidate signal propagation path with metal layer portions 604, 1200, 1202, 1204, 1206 as shown in FIG. 12 for signal propagation track bundle 700. This is shown for two candidate signal propagation paths in FIGS. 13-14 with a candidate signal propagation path with metal layer portions 606, 1300, 1302, 1304, 1306 as shown in FIG. 13; and a candidate signal propagation path with metal layer portions 504, 1400, 1402, 1404, 1406 as shown in FIG. 14 for signal propagation track bundle 702. It will be appreciated that source synchronous process 10 generates 102 candidate signal propagation paths for each combination of signal propagation tracks from each signal propagation track bundle 704 as described above. As shown in FIG. 15, with the candidate signal propagation paths as generated above, source synchronous process 10 saturates metal layer 300 for signal propagation track bundle 700. It will be appreciated that each of the signal propagation tracks for metal layer 300 are similarly saturated in signal propagation track bundles 702, 704 but these are omitted for simplicity. As shown in FIG. 16, with the candidate signal propagation paths as generated above, source synchronous process 10 also saturates metal layer 306 for signal propagation track bundle 700.

In some implementations, generating 102 the plurality of candidate signal propagation paths through the integrated circuit includes skipping 110 every other signal propagation track for each metal layer. For example, while the above candidate signal propagation paths provide full saturation of metal layers 300, 306 in each signal propagation track bundle, crosstalk remains a challenge when signal level transitions on one candidate signal propagation path capacitively charge or discharge a neighboring candidate signal propagation path. Accordingly, source synchronous process 10 provides staggering of adjacent candidate signal propagation paths to reduce crosstalk in the integrated circuit by skipping 110 every other signal propagation track for each metal layer.

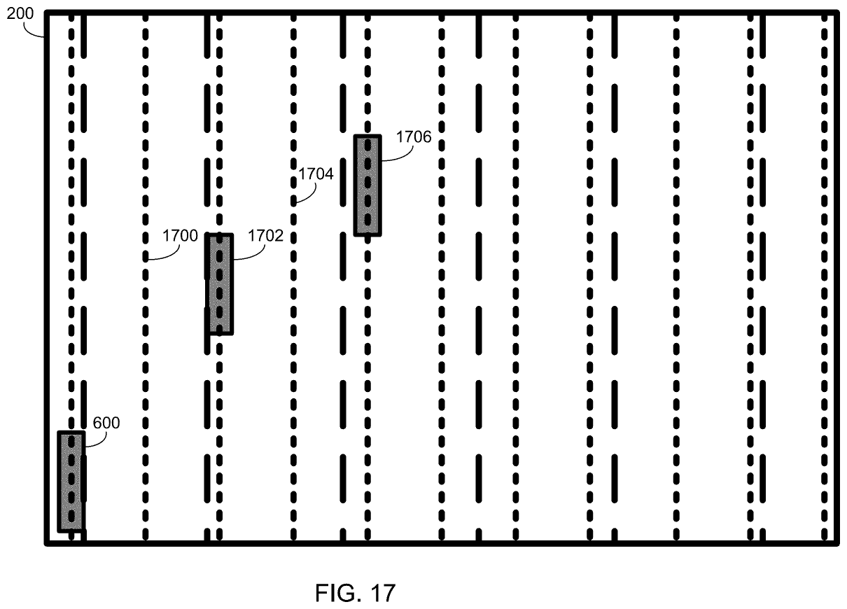

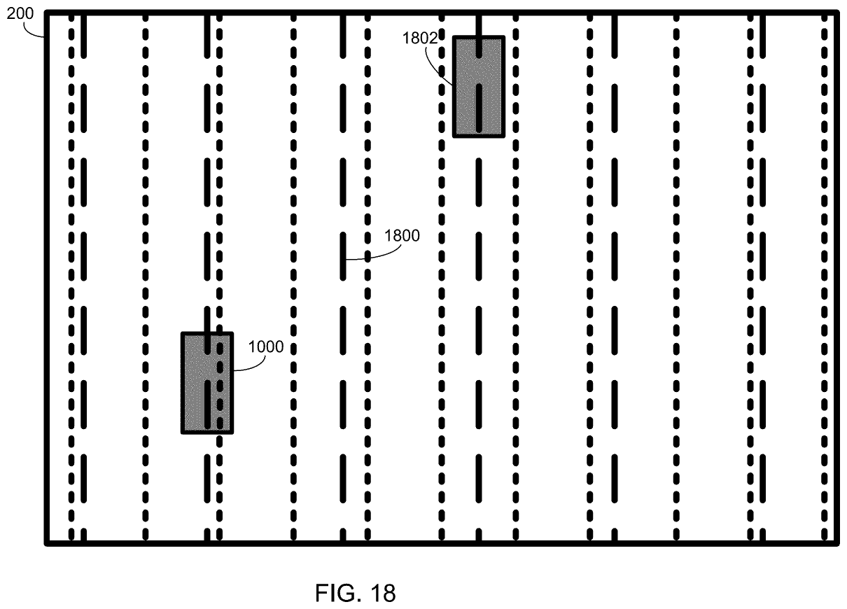

For example and referring also to FIG. 17, source synchronous process 10 generates 102 the plurality of candidate signal propagation paths through the integrated circuit by skipping 110 every other signal propagation track for each metal layer. In the example of FIG. 17, metal layer portion 600 from metal layer 300 is selected but for the next metal layer portion from metal layer 300, signal propagation track 1700 is skipped 110 and metal layer portion 1702 is selected. Additionally, for the third metal layer portion from metal layer 300 to achieve the 3:2 ratio of metal layer 300 to metal layer 306, source synchronous process 10 skips 110 signal propagation track 1704 and selects metal layer portion 1706. Referring also to FIG. 18, source synchronous process 10 selects metal layer portion 1000 for the first signal propagation track for metal layer 306 and skips 110 signal propagation track 1800. To achieve the 3:2 ratio of metal layer 300 to metal layer 300, source synchronous process 10 selects metal layer portion 1802 from the third signal propagation track for metal layer 306. By skipping 110 every other signal propagation path and, as will be discussed in greater detail below, by dividing the plurality of candidate signal propagation paths into a plurality of signal propagation path groups for processing signals, crosstalk between adjacent candidate signal propagation paths is reduced.

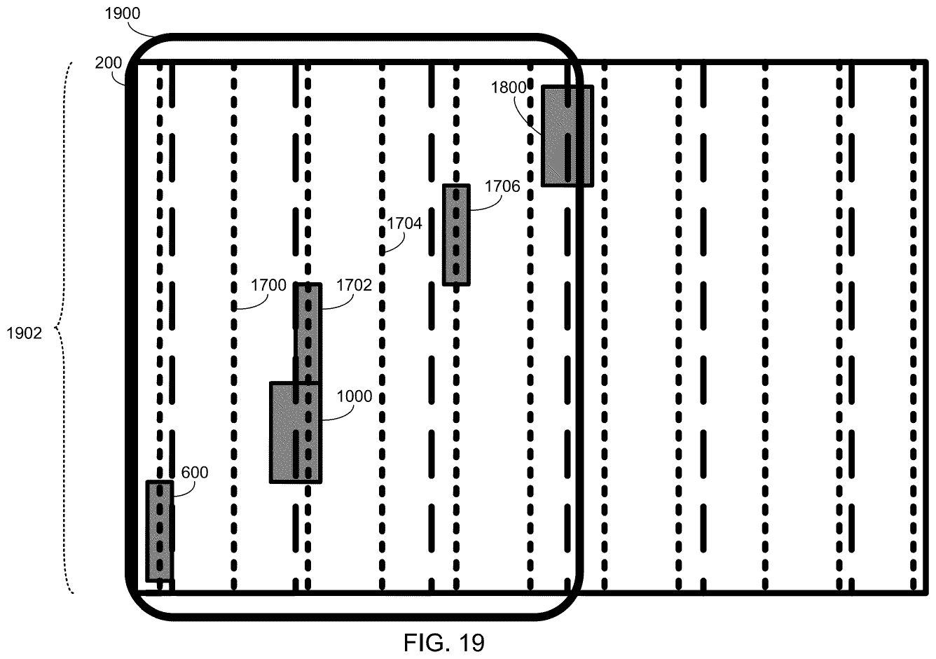

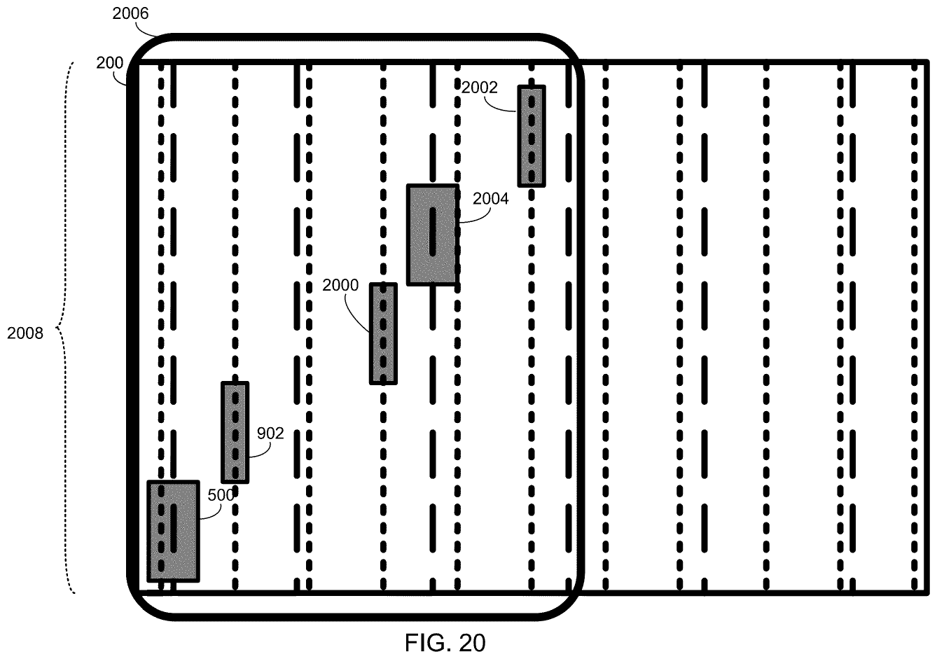

In some implementations, source synchronous process 10 divides 104 the plurality of candidate signal propagation paths into a plurality of candidate signal propagation path groups. Continuing with the above example, source synchronous process 10 generates a candidate signal propagation path as shown in FIG. 19 as the combination of metal portions 600, 1702, 1706 from metal layer 300 and metal portions 1000, 1800 from metal layer 306. Similarly, source synchronous process 10 generates a candidate signal propagation path as shown in FIG. 20 as the combination of metal portions 902, 2000, 2002 from metal layer 300 and metal portions 500, 2004 from metal layer 306. Source synchronous process 10 divides 104 these candidate signal propagation path groups (e.g., signal propagation path group 1900 in FIG. 19 and signal propagation path group 2006 in FIG. 20) with every other signal propagation track assigned to each candidate signal propagation path group. In some implementations, source synchronous process 10 divides candidate signal propagation paths into each signal propagation path group based on whether signal propagation track index for a particular signal propagation track bundle. For example, each signal propagation track in a signal propagation track bundle (i.e., bundle of signal propagation tracks determined for the ratio of metal layer portions to saturate integrated circuit 200) is assigned a signal propagation track index and source synchronous process 10 divides 104 the plurality of candidate signal propagation paths into a first signal propagation path group (e.g., signal propagation path group 1900) for even signal propagation track indices and the remaining candidate signal propagation paths into a second signal propagation path group (e.g., signal propagation path group 2006) for odd signal propagation track indices. In some implementations, source synchronous process 10 divides 104 the plurality of candidate signal propagation paths into candidate signal propagation path groups for each signal propagation track bundle.

In some implementations, source synchronous process 10 generates 106 a first set of signal propagation paths from the plurality of candidate signal propagation paths from a first candidate signal propagation path group. For example, source synchronous process 10 generates 106 first set of signal propagation paths (e.g., signal propagation path 1902 defined using the candidate signal propagation path from candidate signal propagation path group 1900). In some implementations, source synchronous process 10 generates 106 signal propagation path 1902 by assigning a signal to propagate using the candidate signal propagation path of candidate signal propagation path group 1900.

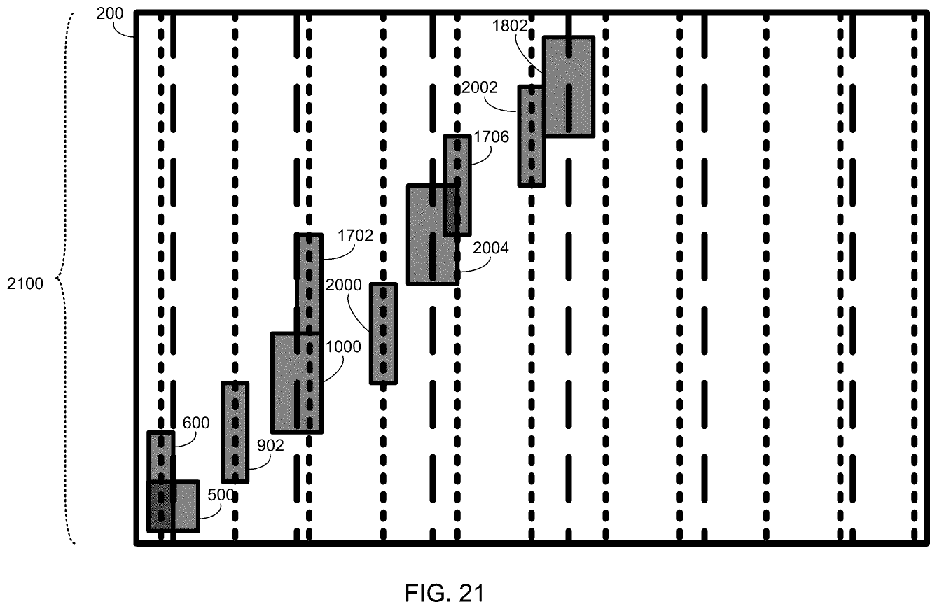

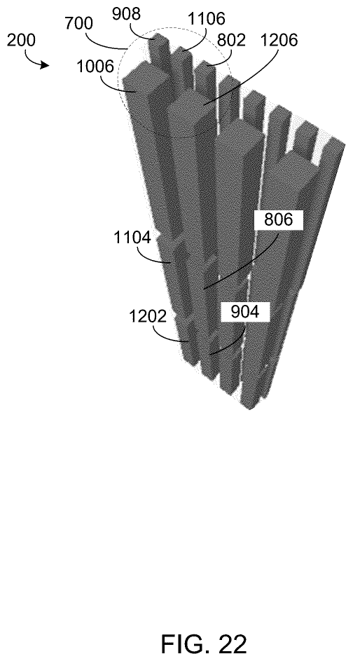

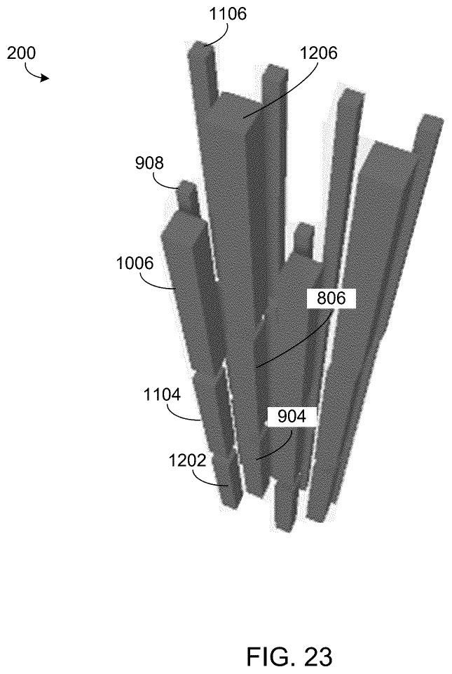

In some implementations, source synchronous process 10 generates 108 a second set of signal propagation paths from the plurality of candidate signal propagation paths from a second candidate signal propagation path group, wherein the second set of signal propagation paths are variably offset from the first set of signal propagation paths. For example, source synchronous process 10 generates 108 a second set of signal propagation paths (e.g., signal propagation path 2100 defined using candidate signal propagation path from candidate signal propagation path group 2006) by variably offsetting candidate signal propagation path 2008 of FIG. 20 by a predefined amount (e.g., a percentage between 0% and 100%). The offset value may be a default value, or may defined by a user. In some implementations, when multiple bits of a signal are propagating through adjacent candidate signal propagation paths, inverter chains and other inner-path logic perform operations on the bits. However, if there is a transition from the inverter chain or inner-path logic on each of the adjacent signal propagation paths at the same time, capacitive charge or discharge can interfere with these transitions and corrupt the data signal and/or the clock signal. Accordingly, source synchronous process 10 offsets signal propagation path 2008 defined using the candidate signal propagation path by a predefined amount. For example and as shown in FIG. 21, the combination of signal propagation path 2100 and signal propagation path 1902 offset by 50% is shown. Referring also to FIGS. 22-23, the offset of signal propagation path 1902 is shown in FIG. 23 compared to the initial non-offset of signal propagation path 1902 as shown in FIG. 22.

In some implementations, the second set of signal propagation paths are 50% offset from the first set of signal propagation paths. For example, source synchronous process 10 can offset the signal propagation paths of each candidate signal propagation path group using a user-defined value and/or a default value. In one example involving multiple signal propagation paths in each candidate signal propagation path group, a 25% offset resulted in 15% reduction in the amount of delay relative to no offsetting; a 50% offset resulted in 23% reduction in the amount of delay relative to no offsetting; and a 75% offset resulted in 15% reduction in the amount of delay relative to no offsetting. Accordingly in this example, source synchronous process 10 offsets the signal propagation paths of each candidate signal propagation path group with a 50% offset for a minimum delay. However, it will be appreciated that different offsets are possible for other combinations of signal propagation paths.

In some implementations, the first set of signal propagation paths and the second set of signal propagation paths are interleaved by propagation direction through the integrated circuit. For example, multiples bits of a data signal and/or a clock signal are propagating through adjacent signal propagation paths. However, if there is a transition on each of the adjacent signal propagation paths at the same time, capacitive charge or discharge can interfere with these transitions and corrupt the data signal and/or the clock signal. Accordingly, source synchronous process 10 interleaves the propagation direction of each signal propagation path to reduce this capacitive charging or discharging. Continuing with the above example, source synchronous process 10 interleaves the propagation direction of signal propagation path 1902 to propagate data signals and/or clock signals in one direction and the propagation direction of signal propagation path 2100 to propagate data signals and/or clock signals in the opposite direction.

In some implementations, the first set of signal propagation paths and the second set of signal propagation paths transmit data signals and clock signals synchronously. For example and as discussed above, by generating signal propagation paths based upon the ratio of metal layer portions from the plurality of metal layers, source synchronous process 10 is able to saturate the plurality of signal propagation tracks through the integrated circuit with multiple signal propagation paths with the same impedance characteristics. Accordingly, both data signals and clock signals are transmitted through integrated circuit (or portions thereof) synchronously (i.e., such that each signal is received within a predefined threshold of one another). In some implementations, the predefined threshold is defined by processing logic (e.g., setup time (i.e., amount of time for which data has be stable before latching clock edge to guarantee processing), hold time (i.e., the amount of time after the clock edge that the data has to be stable for), and/or timing aperture (i.e., the time from the beginning of the setup time to the end of the hold time)). With the interleaving and/or staggering from the offset of the first set of signal propagation paths relative to the second set of signal propagation paths, source synchronous process 10 is able to reduce the impact of crosstalk between adjacent signal propagation paths and ensure synchronous timing (i.e., where the data and clock signals propagate and arrive at the same time) within the integrated circuit.

In some implementations, each of the data signal propagation paths and the plurality of clock signal propagation paths include coaxial shielding. For example, source synchronous timing requires that the data signal and clock signal arrival times match. In some implementations, the delta delay on a clock signal is mirrored onto all of its associated data signals due to min/max timing path modeling. For example, each picosecond of clock crosstalk reduces data signal margin by a similar amount. As the delta delay on the clock path will build across the signal propagation path, it erases any margin between data and clock signals before calculating the data signal crosstalk and delay variation. As such, source synchronous process 10 eliminates the clock signal crosstalk with coaxial shielding. Coaxial shielding includes adding metallic shielding or allocating metal layer portions for shielding between the clock signal propagation path and other signal propagation paths. However, source synchronous process 10 may be unable to include a shield-clock-shield set of signal assignments in the candidate signal propagation path groups due to interleaving and staggering (as discussed above). Accordingly, source synchronous process 10 implements clock signal propagation paths and data signal propagation paths with coaxial shielding within a reserved signal propagation path using the same ratio of metal layer portions used for data signal propagation. In some implementations, source synchronous process 10 assigns clock signals to the signal propagation paths (i.e., clock signal propagation paths) before assigning the data signals (i.e., data signal propagation paths).

### System Overview

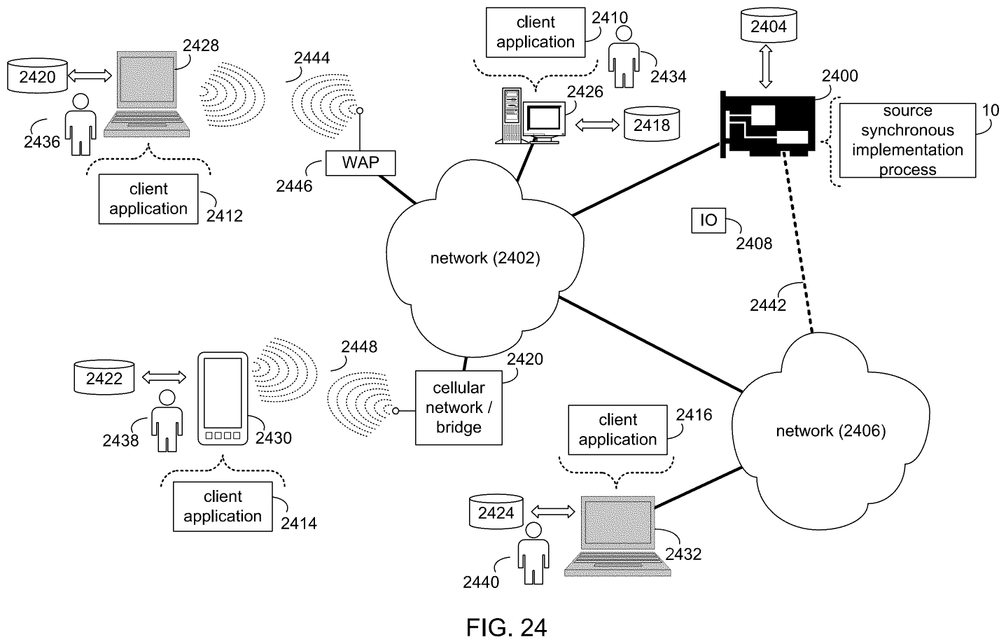

Referring to FIG. 24, a source synchronous process 10 is shown to reside on and is executed by computing system 2400, which is connected to network 2402 (e.g., the Internet or a local area network). Examples of computing system 2400 include a central processing unit (CPU), a graphics processing unit (GPU), multi-core processors, microprocessors, digital signal processors (DSPs) and application-specific integrated circuits (ASIC). In some implementations, computing system 200 includes any processor that is capable of running integrated circuit design software (e.g., very large-scale integration (VLSI) design software). The various components of computing system 2400 execute one or more operating systems, examples of which include: Microsoft® Windows®; Mac® OS X®; Red Hat® Linux®, Windows® Mobile, Chrome OS, Blackberry OS, Fire OS, or a custom operating system (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of source synchronous process 10, which are stored on storage device 2404 included within computing system 2400, are executed by one or more processors (not shown) and one or more memory architectures (not shown) included within computing system 2400. Storage device 2404 may include: a hard disk drive; an optical drive; a RAID device; a random-access memory (RAM); a read-only memory (ROM); and all forms of flash memory storage devices. Additionally or alternatively, some portions of the instruction sets and subroutines of source synchronous process 10 are stored on storage devices (and/or executed by processors and memory architectures) that are external to computing system 2400.

In some implementations, network 2402 is connected to one or more secondary networks (e.g., network 2406), examples of which include: a local area network; a wide area network; or an intranet.

In some implementations, various input/output (IO) requests (e.g., IO request 2408) are sent from client applications 2410, 2412, 2414, 2416 to computing system 2400. Examples of IO request 2408 include data write requests (e.g., a request that content be written to computing system 2400) and data read requests (e.g., a request that content be read from computing system 2400).

The instruction sets and subroutines of client applications 2410, 2412, 2414, 2416, which may be stored on storage devices 2418, 2420, 2422, 2424 (respectively) coupled to client electronic devices 2426, 2428, 2430, 2432 (respectively), may be executed by one or more processors (not shown) and one or more memory architectures (not shown) incorporated into client electronic devices 2426, 2428, 2430, 2432 (respectively). Storage devices 2418, 2420, 2422, 2424 may include: hard disk drives; tape drives; optical drives; RAID devices; random access memories (RAM); read-only memories (ROM), and all forms of flash memory storage devices. Examples of client electronic devices 2426, 2428, 2430, 2432 include personal computer 2426, laptop computer 2428, smartphone 2430, laptop computer 2432, a server (not shown), a data-enabled, and a dedicated network device (not shown). Client electronic devices 2426, 2428, 2430, 2432 each execute an operating system.

Users 2434, 2436, 2438, 2440 may access computing system 2400 directly through network 2402 or through secondary network 2406. Further, computing system 2400 may be connected to network 2402 through secondary network 2406, as illustrated with link line 2442.

The various client electronic devices may be directly or indirectly coupled to network 2402 (or network 2406). For example, personal computer 2426 is shown directly coupled to network 2402 via a hardwired network connection. Further, laptop computer 2432 is shown directly coupled to network 2406 via a hardwired network connection. Laptop computer 2428 is shown wirelessly coupled to network 2402 via wireless communication channel 2444 established between laptop computer 2428 and wireless access point (e.g., WAP) 2446, which is shown directly coupled to network 2402. WAP 2446 may be, for example, an IEEE 802.11a, 802.11b, 802.11g, 802.11n, Wi-Fi®, and/or Bluetooth® device that is capable of establishing a wireless communication channel 2444 between laptop computer 2428 and WAP 2446. Smartphone 2430 is shown wirelessly coupled to network 2402 via wireless communication channel 2448 established between smartphone 2430 and cellular network/bridge 2450, which is shown directly coupled to network 2402.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. For example, TCL may be used to carry out operations of the present disclosure. TCL is a scripting language that is used by various electronic design automation (EDA) tools and systems. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
identifying a plurality of signal propagation tracks within an integrated circuit, wherein the plurality of signal propagation tracks include a plurality of metal layers in a metal stack within the integrated circuit;
generating a plurality of candidate signal propagation paths through the integrated circuit by determining a ratio of metal layer portions from a combination of discrete metal layer portions from the plurality of metal layers of the plurality of signal propagation tracks;
dividing the plurality of candidate signal propagation paths into a plurality of candidate signal propagation path groups;
generating a first set of signal propagation paths from the plurality of candidate signal propagation paths from a first candidate signal propagation path group; and
generating a second set of signal propagation paths from the plurality of candidate signal propagation paths from a second candidate signal propagation path group, wherein the second set of signal propagation paths are variably offset from the first set of signal propagation paths.

2. The computer-implemented method of claim 1, wherein the plurality of metal layers include one or more of:
a plurality of horizontal metal layers; and
a plurality of vertical metal layers.

3. The computer-implemented method of claim 1, wherein the first set of signal propagation paths and the second set of signal propagation paths are interleaved by propagation direction through the integrated circuit.

4. The computer-implemented method of claim 1, wherein the first set of signal propagation paths and the second set of signal propagation paths include a plurality of clock signal propagation paths.

5. The computer-implemented method of claim 4, wherein the first set of signal propagation paths and the second set of signal propagation paths transmit data signals and clock signals source synchronously.

6. The computer-implemented method of claim 1, wherein generating plurality of candidate signal propagation paths through the integrated circuit includes skipping every other signal propagation track for each metal layer.

7. The computer-implemented method of claim 1, wherein the second set of signal propagation paths are 50% offset from the first set of signal propagation paths.

8. A computing system including a processor and memory configured to perform operations comprising:
identifying a plurality of signal propagation tracks within an integrated circuit, wherein the plurality of signal propagation tracks include a plurality of metal layers in a metal stack within the integrated circuit;
generating a plurality of candidate signal propagation paths through the integrated circuit by skipping every other signal propagation track for each metal layer and by determining a ratio of metal layer portions from a combination of discrete metal layer portions from the plurality of metal layers of the plurality of signal propagation tracks;
dividing the plurality of candidate signal propagation paths into a plurality of candidate signal propagation path groups;
generating a first set of signal propagation paths from the plurality of candidate signal propagation paths from a first candidate signal propagation path group; and
generating a second set of signal propagation paths from the plurality of candidate signal propagation paths from a second candidate signal propagation path group, wherein the second set of signal propagation paths are 50% offset from the first set of signal propagation paths.

9. The computing system of claim 8, wherein the plurality of metal layers include one or more of:
a plurality of horizontal metal layers; and
a plurality of vertical metal layers.

10. The computing system of claim 8, wherein the first set of signal propagation paths and the second set of signal propagation paths include a plurality of data signal propagation paths and a plurality of clock signal propagation paths.

11. The computing system of claim 10, wherein the first set of signal propagation paths and the second set of signal propagation paths transmit data signals and clock signals source synchronously.

12. The computing system of claim 10, wherein each of the plurality of clock signal propagation paths and the plurality of data propagation signal paths include coaxial shielding.

13. The computing system of claim 8, wherein the first set of signal propagation paths and the second set of signal propagation paths are interleaved by propagation direction through the integrated circuit.

14. The computing system of claim 8, wherein generating the plurality of candidate signal propagation paths through the integrated circuit includes generating candidate signal propagation paths include a plurality of discrete metal layer portions with the same impedance characteristics.

15. A computer program product residing on a computer readable medium having a plurality of instructions stored thereon which, when executed by a processor, cause the processor to perform operations comprising:
identifying a plurality of signal propagation tracks within an integrated circuit, wherein the plurality of signal propagation tracks include a plurality of metal layers in a metal stack within the integrated circuit;
generating a plurality of candidate signal propagation paths through the integrated circuit by skipping every other signal propagation track for each metal layer and by determining a ratio of metal layer portions from a combination of discrete metal layer portions from the plurality of metal layers;
dividing the plurality of candidate signal propagation paths into a plurality of candidate signal propagation path groups;
generating a first set of signal propagation paths from the plurality of candidate signal propagation paths from a first candidate signal propagation path group; and
generating a second set of signal propagation paths from the plurality of candidate signal propagation paths from a second candidate signal propagation path group, wherein the second set of signal propagation paths are 50% offset from the first set of signal propagation paths, wherein the first set of signal propagation paths and the second set of signal propagation paths transmit data signals and clock signals source synchronously.

16. The computer program product of claim 15, wherein the plurality of metal layers include one or more of:
a plurality of horizontal metal layers; and
a plurality of vertical metal layers.

17. The computer program product of claim 15, wherein the first set of signal propagation paths and the second set of signal propagation paths are interleaved by propagation direction through the integrated circuit.

18. The computer program product of claim 15, wherein the first set of signal propagation paths and the second set of signal propagation paths include a plurality of data signal propagation paths and a plurality of clock signal propagation paths.

19. The computer program product of claim 18, wherein each of the data signal propagation paths and the plurality of clock signal propagation paths include coaxial shielding.

20. The computer program product of claim 18, wherein generating the plurality of candidate signal propagation paths through the integrated circuit includes generating candidate signal propagation paths include a plurality of discrete metal layer portions with the same impedance characteristics.
